(19) United States
(12) Patent Application Publication
(10) Pub. No.: US 2010/0073698 A1
(43) Pub. Date: Mar. 25, 2010

(54) IMAGE PROCESSING APPARATUS, IMAGE FORMING APPARATUS AND COMPUTER READABLE MEDIUM FOR IMAGE PROCESSING

(76) Inventor: Shunichiro Shishikura, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/545,490

(22) Filed: Aug. 21, 2009

(30) Foreign Application Priority Data
Sep. 24, 2008 (JP) P2008-244981

(51) Int. Cl. G06F 15/00

(52) U.S. Cl. 358/1.9

(57) ABSTRACT

An image processing apparatus includes an image information acquiring unit that acquires image information; a line region setting unit that sets a line region in an image indicated by the image information acquired by the image information acquiring unit; and a background correcting unit that corrects an image density of a background portion of the image in a region set to be the line region by the line region setting unit.

### CROSS-REFERENCE TO RELATED APPLICATION

This application is based on and claims priority under 35 USC 119 from Japanese Patent Application No. 2008-244981 filed on Sep. 24, 2008.

### BACKGROUND

1. Technical Field

The present invention relates to an image processing apparatus, an image forming apparatus and a program.

2. Related Art

It has been tried to reduce a line width of a bar code and to increase a type of the line width, thereby increasing an information amount of the bar code. Therefore, there is required a technique for forming an image of a thin line such as a bar code with high precision. In some cases in which the image of the thin line is formed, the line width is increased by an influence of a potential difference on a boundary between an exposing portion and a non-exposing portion over a photosensitive member, that is, a gradient of the potential difference on the boundary is increased so that a toner facing the non-exposing portion is also attracted.

### SUMMARY

According to an aspect of invention, an image processing apparatus includes an image information acquiring unit that acquires image information; a line region setting unit that sets a line region in an image indicated by the image information acquired by the image information acquiring unit; and a background correcting unit that corrects an image density of a background portion of the image in a region set to be the line region by the line region setting unit.

### BRIEF DESCRIPTION OF THE DRAWINGS

Exemplary embodiments of the invention will be described in detail based on the following figures, wherein:

FIG. 1 is a block diagram showing a function of an image forming apparatus,

FIG. 2 is a view showing a hardware structure of the image forming apparatus,

FIG. 3 is a view showing an example of an image of an image forming target,

FIG. 4A is a chart showing a corresponding relationship between input Cin through a first conversion LUT and Cin after a correction,

FIG. 4B is a chart showing a corresponding relationship between input Cin through a second conversion LUT and Cin after a correction,

FIG. 5 is a chart showing a corresponding relationship between the Cin and an output image concentration (Dout),

FIG. 6 is a diagram showing an example of image data in a line region before and after the correction,

FIG. 7 is a diagram showing a relationship among a charging potential, a feeble exposing potential, a developing bias potential and an exposing potential in a photosensitive member, and

FIG. 8 is a flowchart showing an image formation processing.

### DETAILED DESCRIPTION

A preferred exemplary embodiment (hereinafter referred to as an exemplary embodiment) for carrying out the invention will be described below with reference to the drawings.

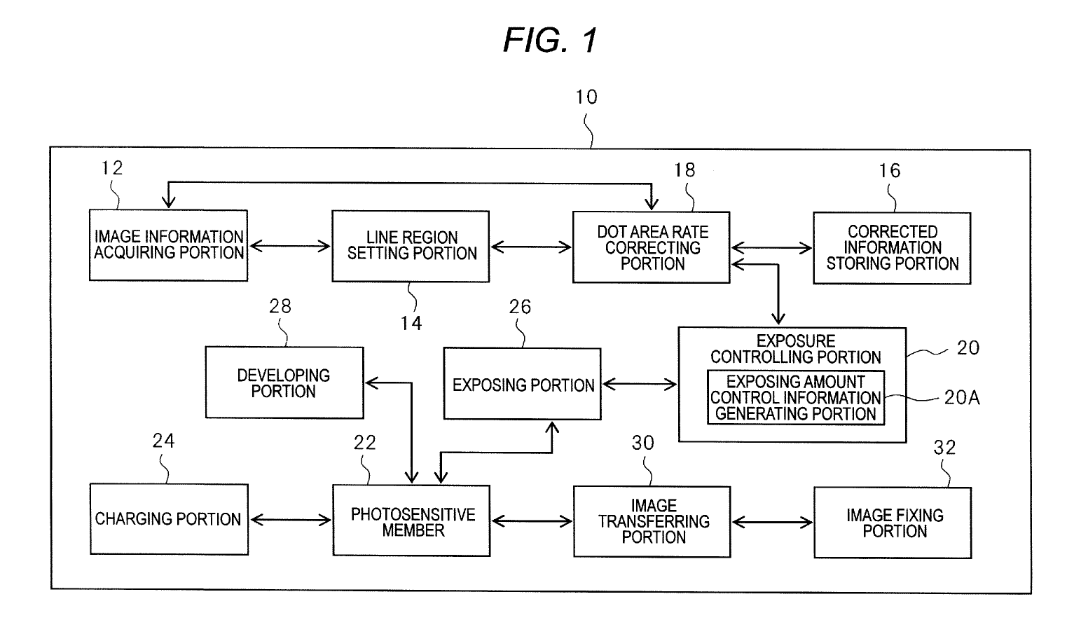

FIG. 1 is a block diagram showing a function of an image forming apparatus 10 according to the exemplary embodiment. As shown in FIG. 1, the image forming apparatus 10 includes an image information acquiring portion 12 used as an image information acquiring portion according to the exemplary embodiment, a line region setting portion 14 used as a line region setting portion according to the exemplary embodiment, a corrected information storing portion 16, a dot area rate correcting portion 18 used as non-image portion correcting unit according to the exemplary embodiment, an exposure controlling portion 20, a photosensitive member 22 used as a photosensitive member according to the exemplary embodiment, a charging portion 24, an exposing portion 26 used as exposing unit according to the exemplary embodiment, a developing portion 28 used as developing unit according to the exemplary embodiment, and an image transferring portion 30 and an image fixing portion 32 which are used as image transferring portions according to the exemplary embodiment.

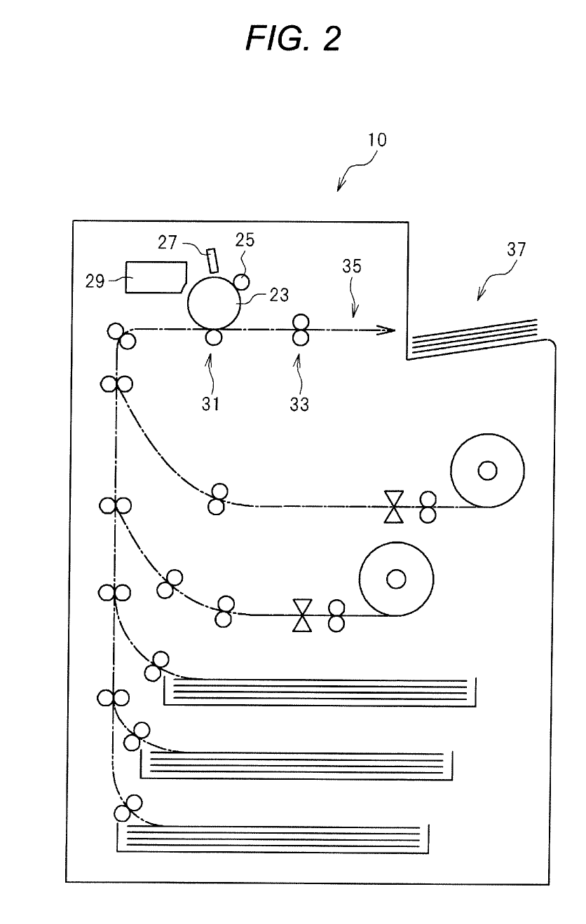

FIG. 2 is a view showing a hardware structure of the image forming apparatus 10. The image forming apparatus 10 can also include hardware constituting a computer, for example, controlling unit constituted by a CPU which is not shown, storing unit constituted by a semiconductor memory unit or a magnetic disk device, and input/output unit constituted by an input/output interface, and hardware such as a photosensitive drum 23, a charging device 25, an LED array 27, a developing device 29, a transferring roll 31 and a fixing device 33, a delivering belt 35 and a tray 37, thereby implementing a function of each of the portions. The image forming mechanism may be provided for each of colors of C, M, Y and K, which is not shown in FIG. 2 for simplicity. The image information acquiring portion 12, the line region setting portion 14, the corrected information storing portion 16, the dot area rate correcting portion 18 and the exposure controlling portion 20 may be implemented by reading a program stored in a computer readable information storing medium to the image forming apparatus 10 by using a medium reading device (not shown) and executing the same program. The program may be supplied to the image forming apparatus 10 by the information storing medium or may be supplied through a data communication network such as Internet.

The image information acquiring portion 12 acquires image information to be an image forming target. The image information may be raster data or data in a PDL format. In case of the data in the PDL format, the image information acquiring portion 12 rasterizes the data in the PDL format to generate raster data.

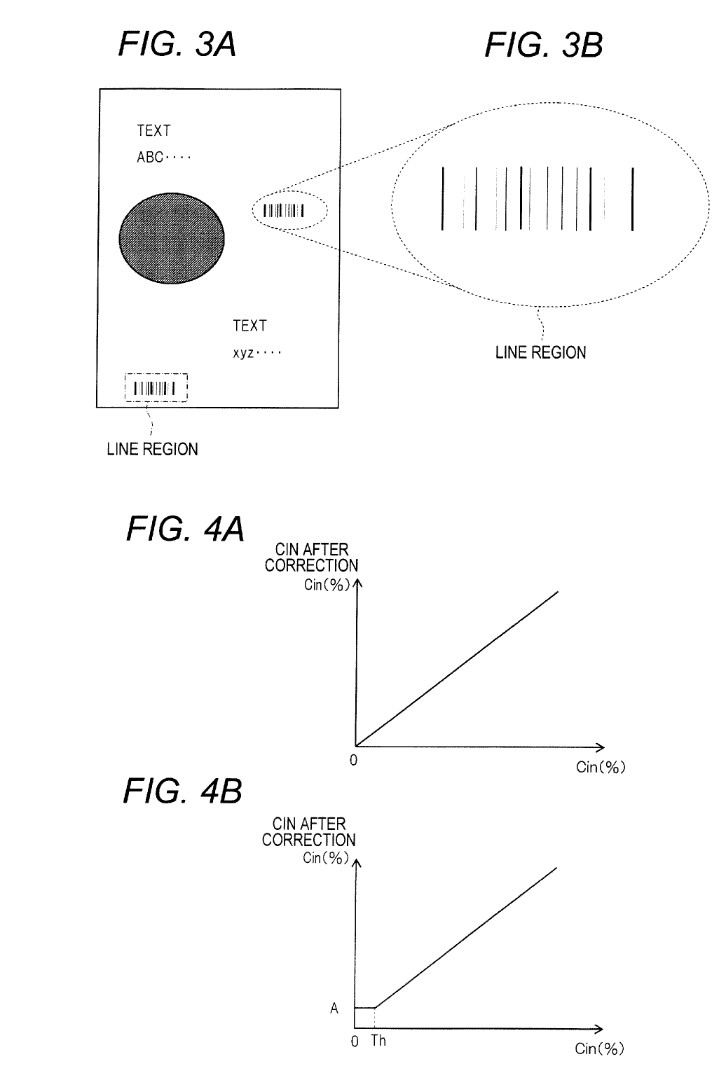

FIG. 3 shows an example of an image to be an image forming target through the image forming apparatus 10 according to the exemplary embodiment. As shown in FIG. 3(A), image data to be the image forming target include a thin line image such as a bar code together with a text and a graphic object. FIG. 3(B) shows a bar code image which is enlarged. A line constituting the bar code includes various line widths.

The image forming apparatus 10 according to the exemplary embodiment serves to selectively change a line region containing a line image such as a bar code image in the image data to be the image forming target into an image which is suitable for forming a thin line. Although the bar cord region is set to be the line region in the exemplary embodiment, the bar code is not restrictively set to the line region. The line region contains a front line and a line to be expressed thinly and is not restricted to a straight line but contains a curve. Detailed description will be given to a structure provided in the image forming apparatus 10 in order to implement the processing.

The line region setting portion 14 sets a region in which an image is formed in a line image optimizing mode in the images to be the image forming targets (which will be hereinafter referred to as a line region). The line image optimizing mode implies a processing mode for carrying out a suitable control for forming a thin line to form a line image with high precision, thereby forming a latent image as described above.

The line region setting portion 14 may set the line region based on a designation of a user for the image to be the image forming target or may specify a region containing a line image based on an image characteristic amount such as an edge component of the image to be the image forming target, thereby setting the specified region to be the line region. In this case, the line region setting portion 14 may set, as the line region, a region for comprehensively covering plural of lines, may set the line region to each of the lines or may simply change an image density around the line image. To the contrary, the line region may be set to a whole document or a mode for setting the line region to the whole document may be provided independently.

The corrected information storing portion 16 stores a conversion LUT (Look Up Table) for correcting a dot area rate (Coverage in which will be hereinafter referred to as Cin) of the image data to be the image forming target. In the exemplary embodiment, the conversion LUT includes the following first and second conversion LUTs.

First of all, FIG. 4A shows a corresponding relationship between input Cin of a first conversion LUT and Cin after a correction. As shown in FIG. 4A, in the exemplary embodiment, it is assumed that the input Cin and the Cin after the correction have a proportional relationship and the Cin after the correction is also set to be “0” if the input Cin is “0” in the first conversion LUT.

Next, FIG. 4B shows a corresponding relationship between input Cin of a second conversion LUT and Cin after a correction. As shown in FIG. 4B, in the exemplary embodiment, the Cin after the correction is set to be zero in the first conversion LUT when the input Cin is zero, while a greater positive value of A is set in the second conversion LUT. The Cin after the correction is fixed to be the positive value of A when the input Cin is 0 to Th, and the same curve as the first conversion LUT is expressed when the input Cin is equal to or greater than the Th. In the case in which the dot area rate of the image is corrected by the second conversion LUT, an input of A is set even if the input Cin is equal to or smaller than the Th.

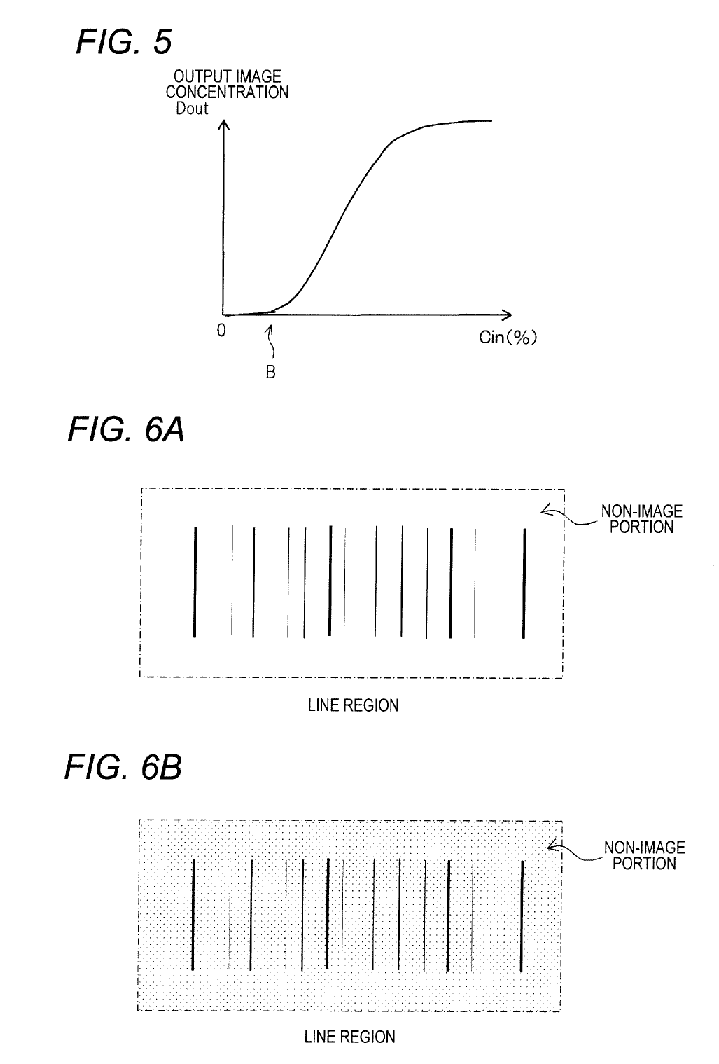

FIG. 5 shows a corresponding relationship between Cin and an output image concentration (Dout). As shown in FIG. 5, when the Cin exceeds B, the output image concentration is rapidly raised and the point is set to be fogging Cin. In the second conversion LUT, the value of A may be set to be slightly smaller than the fogging Cin. The image data in the line region are corrected by the second conversion LUT so that the data having the Cin in original image data which is equal to or smaller than the Th are exposed in a fogging concentration or less.

Referring to a normal image region other than the line region set by the line region setting portion 14, the dot area rate correcting portion 18 used as the non-image correcting unit according to the exemplary embodiment corrects the dot area rate of the image data by using the first conversion LUT stored in the corrected information storing portion 16 and corrects the dot area rate of the image data by using the second conversion LUT for the line region. Thus, the area rate of the non-image portion is corrected.

FIG. 6 shows an example of the image data in the line region before and after the correction. FIG. 6(A) shows the image data in the line region before the correction and FIG. 6(B) shows the image data in the line region after the correction. As shown in FIGS. 6(A) and 6(B), the non-image portion in FIG. 6(B) has a higher dot area rate than that in the non-image portion of FIG. 6(A), that is, is corrected to have a higher concentration because the Cin is offset to have a positive value for the non-image portion in FIG. 6(A).

The exposure controlling portion 20 controls an exposure to the photosensitive member 22 through the exposing portion 26 which will be described below. In the exemplary embodiment, the exposure controlling portion 20 includes an exposing amount control information generating portion 20A and serves to generate exposure data which designate a portion to be exposed for each position of an image to be formed on the photosensitive member.

The exposing amount control information generating portion 20A generates exposure data for carrying out an exposure based on the dot area rate of the image data to be the image forming target which is corrected by the dot area rate correcting portion 18. The exposure controlling portion 20 outputs the generated exposure data to the exposing portion 26.

It is also possible to detect, through a concentration sensor, a region exposed with a change in a dot area rate for a previous exposure, and to decide a fogging dot area rate at which a development is started, thereby setting a value to be smaller than the fogging dot area rate thus decided.

The photosensitive member 22 has an insulator property in a dark place and has a conductor property in a bright place, and may be implemented by the photosensitive drum 23. The photosensitive member 22 is changed to be positive or negative in the dark place to have an electric charge to stick a toner, and a portion exposed by the exposing portion 26 which will be described below is changed into a conductor so that the electric charge is lost.

The charging portion 24 serves to uniformly charge a surface of the photosensitive member 22 into a predetermined potential (a charging potential) and may be implemented by the charging device 25. For example, in the exemplary embodiment, the charging potential is set to be −700 V.

The exposing portion 26 serves to expose a laser beam to the photosensitive member 22 based on exposure data input from the exposure controlling portion 20, thereby forming an electrostatic latent image on the photosensitive member 22, and may be implemented by the LED array 27. A portion to which the laser beam is exposed in the photosensitive member 22 loses the electric charge. A portion having low fogging Cin set thereto loses the electric charge but 0V is not reached through a feeble exposure. Since the exposing amount is smaller than the fog exposing amount, moreover, the electric charge is eliminated from the charging potential to a part between the charging potential and a developing bias potential. The potential at this time will be referred to as a feeble exposing potential.

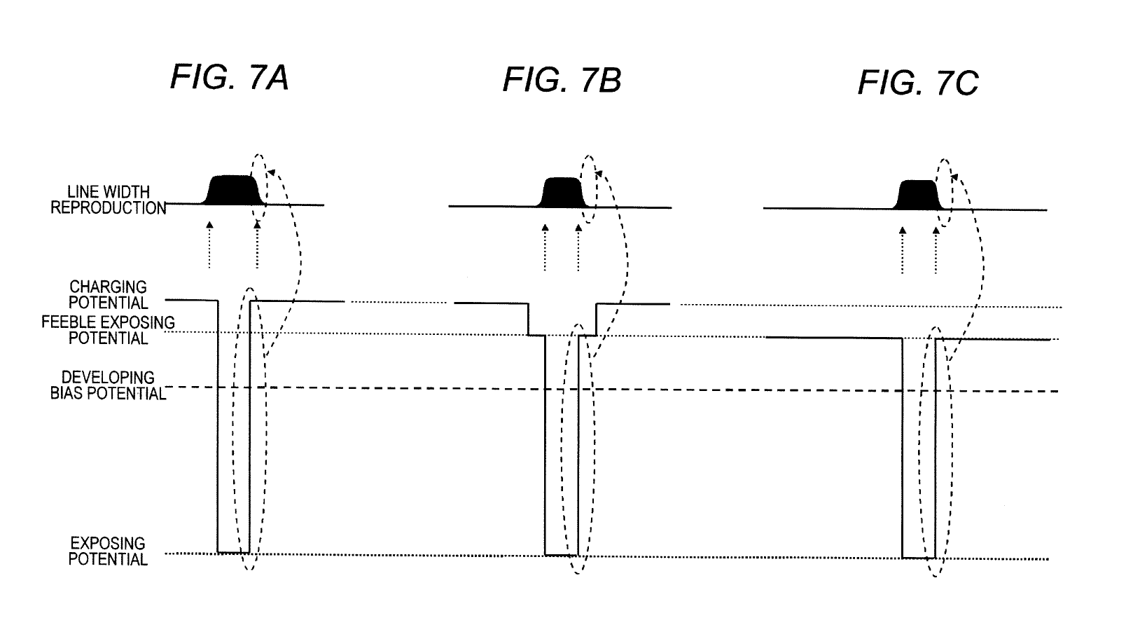

FIG. 7 shows a relationship among the charging potential, the feeble exposing potential, the developing bias potential and the exposing potential in the photosensitive member 22. FIG. 7(A) shows a potential relationship in a normal image region, FIG. 7(B) shows a potential relationship in a line region in the case in which the line region is provided for each line, and FIG. 7(C) shows a potential relationship in a line region in the case in which the line region is provided to include plural of lines.

As shown in FIG. 7(A), the feeble exposure is not carried out for the normal image region. Therefore, an electrostatic latent image is expressed by the charging potential and the exposing potential, and a potential difference is rapidly changed in an exposing portion and a non-exposing portion. For this reason, a line width to be reproduced is enlarged over a boundary between the image portion and the non-image portion. The boundary between the image portion and the non-image portion will be referred to as an edge portion.

On the other hand, as shown in FIG. 7(B), in the case in which a circumference of a line is subjected to the feeble exposure, the potential difference between the exposing portion and the non-exposing portion has a gradient reduced more greatly through the feeble exposing potential between the charging potential and the developing bias potential as compared with the case of the normal image region. Therefore, it is possible to reduce an influence of the edge portion, thereby suppressing an increase in a line width to be reproduced.

As shown in FIG. 7(C), moreover, also in the case in which the line region is provided in a region containing plural of lines, the exposing portion and the non-exposing portion have a potential difference between the feeble exposing potential and the exposing potential. Therefore, the gradient is smaller than that in the case of the normal image region. Consequently, it is possible to reduce the influence of the edge portion, thereby suppressing an increase in a line width to be reproduced.

The developing portion 28 serves to stick a charged toner to an electrostatic latent image formed by exposing the photosensitive member 22, thereby forming a toner image, and may be implemented by the developing device 29. For example, the developing portion 28 may be provided with a counter electrode of −600 V opposite to the photosensitive member 22 to stick a toner charged to be negative onto the electrostatic latent image formed on the photosensitive member 22.

The image transferring portion 30 serves to transfer the toner image formed on the surface of the photosensitive member 22 to a recording medium such as a paper, and may be implemented by the transferring roll 31. When transferring, to the recording medium, the toner image formed on the surface of the photosensitive member 22, the image transferring portion 30 gives a positive transfer field to a back side of the surface of the recording medium to which the toner image is transferred, thereby transferring the toner to the recording medium easily.

The image fixing portion 32 serves to apply heat to the toner, and at the same time, to pressurize the recording medium having the toner stuck thereto from both sides, thereby fixing the toner, and may be implemented by the fixing device 33. After the surface of the recording medium to which the toner is fixed is cleaned, the recording medium is discharged from the image forming apparatus 10 to the tray 37.

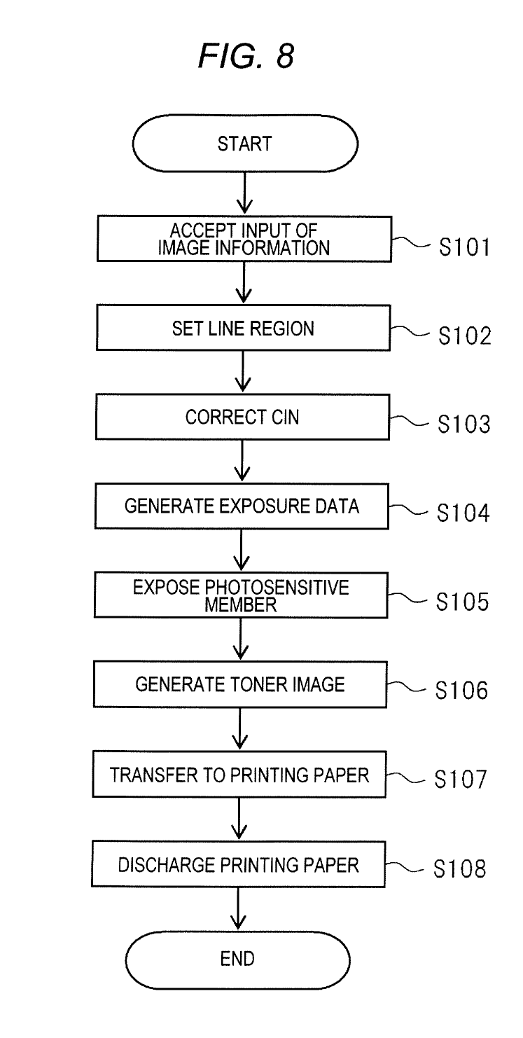

Next, a flow of an image formation processing to be executed by the image forming apparatus 10 will be described with reference to a flowchart of FIG. 8.

As shown in FIG. 8, the image forming apparatus 10 accepts an input of image information about a forming target (S101). Then, the image forming apparatus 10 sets a line region containing a line image in the image information thus accepted (S102). The line region may be set based on an input of a user or an image processing. A region other than the line region in the image information is set to be a standard image region.

Subsequently, the image forming apparatus 10 corrects a value (Cin) input based on a first LUT if an image forming unit of the image information is contained in the standard image region and corrects a value (Cin) input based on a second LUT if the image forming unit is contained in the line region for each image forming unit (S103). The image forming apparatus 10 generates exposure data for controlling an exposing amount in a formation of a latent image on the photosensitive member based on the image information having the input value corrected on the basis of the same image information (S104).

The image forming apparatus 10 exposes the photosensitive member 22 based on the exposure data thus generated (S105). Referring to the line region, a background portion in which a line image is not formed is also subjected to a feeble exposure based on an input coverage which is corrected based on the second LUT. The image forming apparatus 10 sticks a toner to an electrostatic latent image portion formed on the photosensitive member 22 by the exposure, thereby generating a toner image (S106). The image forming apparatus 10 transfers the formed toner image to a printing paper (S107) and then fixes the toner image, and discharges the printing paper (S108).

In the image forming apparatus 10 described above, the line region in which the image to be the image forming target is formed in the line image optimizing mode is set, and the line region thus set is subjected to the feeble exposure to prevent the influence of the edge portion from occurring in the line region.

The invention is not restricted to the exemplary embodiment but it is also possible to set, as the line region, the portion other than the portion in which the image object is formed in the image to be the forming target, for example.

### Second Exemplary Embodiment

Although the description has been given to the image forming apparatus for exposing the image portion in the exemplary embodiment, the image forming apparatus is set to be a non-image exposing image forming apparatus for exposing a non-image portion in a second exemplary embodiment. In the second exemplary embodiment, a toner is moved from a developing device to a portion of a photosensitive member which is not exposed, and an image is formed in that portion. An exposure controlling portion 20 carries out a control for exposing the non-image portion in a larger exposing amount than a fog exposing amount.

### Third Exemplary Embodiment

Although the image processing is carried out in the image forming apparatus to be a single housing in the exemplary embodiments, it is assumed that an image processing is executed in a previous stage to a transmission of an image to the image forming apparatus in a third exemplary embodiment. In the third exemplary embodiment, a data file is created by a personal computer, and the data file thus created is stored in a memory. A CPU reads the data file from the memory depending on operating information accepted by an input device such as a keyboard (which corresponds to a processing to be executed by image information acquiring unit), and sets a region desired to enhance a thin line reproducibility in printing as a line region depending on the operating information accepted by the input device such as a mouse in an image indicated by the read data file (which corresponds to a processing to be executed by line region setting unit). In this case, the whole image indicated by the data file may be set to be the line region. When the line region is set, a print processing portion provided in the personal computer used as non-image portion correcting unit according to the third exemplary embodiment corrects an image density of a non-image portion. When accepting an instruction for printing, the personal computer transmits image data processed in the print processing portion to the image forming apparatus according to the third exemplary embodiment. In the image forming apparatus, a corresponding portion to the image data is exposed so that a printing operation is executed based on the image data transmitted from the personal computer. In the case in which plural of image forming apparatuses is connected to the personal computer, the print processing portion may determine an image density of the non-image portion based on a characteristic such as a difference between fog starting potentials of the individual image forming apparatuses. Moreover, a program for causing the personal computer to execute a processing to be carried out before the printing operation may be installed in the personal computer by using a computer readable recording medium such as a DVD.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image processing apparatus comprising:
an image information acquiring unit that acquires image information;
a line region setting unit that sets a line region in an image indicated by the image information acquired by the image information acquiring unit; and
a background correcting unit that corrects an image density of a background portion of the image in a region set to be the line region by the line region setting unit.

2. The image processing apparatus according to claim 1, wherein the image of the background portion to be corrected by the background correcting unit is constituted by a dot.

3. An image forming apparatus comprising:
an image processing apparatus according to claim 1;
a photosensitive member;
a charging portion that charges the photosensitive member;
an exposing unit that exposes a portion of the photosensitive member charged by the charging portion which has an image processed by the image processing apparatus; and
a developing unit that develops the portion which is exposed by the exposing unit,
wherein a charging potential of the photosensitive member in the region corrected by the background correcting unit is set between a charging potential and a developing potential.

4. An image forming apparatus comprising:
an image processing apparatus according to claim 1;
a photosensitive member;
a charging portion that charges the photosensitive member;
an exposing unit that exposes a portion of the photosensitive member charged by the charging portion which has an image processed by the image processing apparatus; and
a developing unit that develops the portion which is exposed by the exposing unit,
wherein a charging potential of the photosensitive member in the region corrected by the background correcting unit is set between an antistatic potential and a developing potential.

5. A computer readable medium storing a program causing a computer to execute a process for correcting a background portion, the process comprising:
acquiring image information;
setting a line region in an image indicated by image information; and
correcting an image density of a background portion in a region set to be the line region by the line region setting unit.

6. A method of an image processing, comprising;
acquiring image information;
setting a line region in an image indicated by image information; and
correcting an image density of a background portion in a region set to be the line region by the line region setting unit.
